(19) United States
(12) Patent Application Publication
(10) Pub. No.: US 2024/0017697 A1
(43) Pub. Date: Jan. 18, 2024

(54) VEHICLE CONTROL SYSTEM AND CONTROL METHOD

(71) Applicant: PANASONIC INTELLECTUAL PROPERTY MANAMGNEMTN CO., LTD., Osaka (JP)

(72) Inventors: Hitoshi NAMBA, Kanagawa (JP); Genki SAITO, Kanagawa (JP)

(21) Appl. No.: 18/478,209

(22) Filed: Sep. 29, 2023

Related U.S. Application Data
(63) Continuation of application No. PCT/JP21/39185, filed on Oct. 22, 2021.

(30) Foreign Application Priority Data
Mar. 29, 2021 (JP) 2021-055590

(51) Int. Cl. B60R 25/24; G01S 11/06; G01S 11/08

(52) U.S. Cl. CPC B60R 25/245; G01S 11/06; G01S 11/08; B60R 2325/101

(57) ABSTRACT

A vehicle and an electronic key perform wireless communication conforming to Bluetooth using at least a first electromagnetic wave of a first wavelength, estimate a second distance based on at least electric field strength and/or electromagnetic wave arrival time of the first electromagnetic wave of the first wavelength, and do not perform distance estimation based on at least a phase difference between a second electromagnetic wave of a second wavelength and a third electromagnetic wave of a third wavelength until a condition that the estimated second distance is smaller than a second distance threshold and a change in the estimated second distance is greater than a predetermined change is satisfied.

### CROSS-REFERENCE TO RELATED APPLICATIONS

This is a continuation of International Application No. PCT/JP2021/039185 filed on Oct. 22, 2021, and claims priority from Japanese Patent Application No. 2021-055590 filed on Mar. 29, 2021, the entire content of which is incorporated herein by reference.

### TECHNICAL FIELD

The present disclosure relates to a vehicle control system and a control method suitable for use in a vehicle such as a motorcycle or an automatic vehicle.

### BACKGROUND ART

In recent years, an electronic key system using Bluetooth (registered trademark) communication has been studied in a vehicle such as a motorcycle and an automatic vehicle. In Bluetooth communication using a high-frequency band, since accurate distance estimation cannot be performed using electric field strength (received signal strength indication: RSSI) and electromagnetic wave arrival time (time of flight: ToF), a ranging technology (phase-based ranging) using phase difference information has been proposed. For example, Patent Literatures 1 and 2 disclose that a distance between two devices is calculated using two or more phase detection results.

### CITATION LIST

### Patent Literature

Patent Literature 1: JP2018-155724A

Patent Literature 2: JP2018-155725A

### SUMMARY OF INVENTION

However, in the ranging technology using the phase difference information, since the distance estimation accuracy is proportional to the number of times of communication, power consumption increases if highly accurate distance estimation is continuously performed within the Bluetooth communication range. In a vehicle control system that enables vehicle control using a mobile terminal such as an electronic key, it is important to save power to enable long-term operation of the mobile terminal possessed by a user. As a power-saving plan in the vehicle control system, there is a method in which an acceleration sensor is mounted in the mobile terminal, and distance is measured only when the mobile terminal is moving, but the addition of the acceleration sensor increases the price. In particular, it is difficult to apply to motorcycles in terms of price and power consumption.

An object of the present disclosure is to provide a vehicle control system and a control method that can achieve power saving at a price applicable to motorcycles.

The vehicle control system of the present disclosure includes a vehicle and a mobile terminal. The vehicle includes at least a vehicle body and a first wheel and a second wheel coupled to the vehicle body, and is movable by the first wheel and the second wheel. The mobile terminal and the vehicle are capable of wireless communication using at least a first electromagnetic wave of a first wavelength, a second electromagnetic wave of a second wavelength, and a third electromagnetic wave of a third wavelength. When wireless communication is performed between the vehicle and the mobile terminal using at least the first electromagnetic wave of the first wavelength and a predetermined condition is satisfied, a distance between the vehicle and the mobile terminal is estimated using at least the second electromagnetic wave of the second wavelength and the third electromagnetic wave of the third wavelength, and when the distance is smaller than a predetermined distance threshold, an operation of the vehicle is permitted. The distance between the vehicle and the mobile terminal is estimated using at least the second electromagnetic wave of the second wavelength and the third electromagnetic wave of the third wavelength, and when the distance is greater than the predetermined distance threshold, the operation of the vehicle is not permitted. The second wavelength and the third wavelength are different from each other.

According to the present disclosure, in the wireless communication between the vehicle and the mobile terminal using at least the first electromagnetic wave of the first wavelength, since the distance estimation using at least the second electromagnetic wave of the second wavelength and the third electromagnetic wave of the third wavelength is not performed until the predetermined condition is satisfied, the power used for the distance estimation can be reduced. In addition, since a component such as an acceleration sensor that increases the price is not used, power saving can be implemented at low costs, and the present invention can be applied to motorcycles that are constrained in terms of price and power consumption.

In the vehicle control system of the present disclosure, in the above configuration, the distance between the vehicle and the mobile terminal is estimated based on at least a phase difference between the second electromagnetic wave of the second wavelength and the third electromagnetic wave of the third wavelength.

According to the present disclosure, the distance between the vehicle and the mobile terminal can be estimated with high accuracy by estimating the distance between the vehicle and the mobile terminal using at least the phase difference between the second electromagnetic wave and the third electromagnetic wave.

In the vehicle control system of the present disclosure, in the above configuration, the distance is set as a first distance, the distance threshold is set as a first distance threshold, the predetermined condition is when a second distance estimated based on at least electric field strength and/or electromagnetic wave arrival time of the first electromagnetic wave of the first wavelength is smaller than a second distance threshold, and the second distance threshold is greater than the first distance threshold.

According to the present disclosure, since the distance estimation using at least the second electromagnetic wave of the second wavelength and the third electromagnetic wave of the third wavelength is not performed until the distance between the vehicle and the mobile terminal, that is, the second distance is smaller than the second distance threshold, the power used for the distance estimation can be reduced.

In the vehicle control system of the present disclosure, in the above configuration, the distance is set as a first distance, the distance threshold is set as a first distance threshold, the predetermined condition is when a second distance estimated based on at least electric field strength and/or electromagnetic wave arrival time of the first electromagnetic wave of the first wavelength is smaller than a second distance threshold and when a change in the estimated second distance is greater than a predetermined change, and the second distance threshold is greater than the first distance threshold.

According to the present disclosure, since the distance estimation using at least the second electromagnetic wave of the second wavelength and the third electromagnetic wave of the third wavelength is not performed until the distance between the vehicle and the mobile terminal, that is, the second distance is smaller than the second distance threshold and the change in the second distance is greater than the predetermined change, the power used for the distance estimation can be reduced.

In the vehicle control system of the present disclosure, in the above configuration, the distance is set as a first distance, and the predetermined condition is when a change in a second distance estimated based on at least electric field strength and/or electromagnetic wave arrival time of the first electromagnetic wave of the first wavelength is greater than a predetermined change.

According to the present disclosure, since the distance estimation using at least the second electromagnetic wave of the second wavelength and the third electromagnetic wave of the third wavelength is not performed until the distance between the vehicle and the mobile terminal, that is, the change in the second distance is greater than the predetermined change, the power used for the distance estimation can be reduced.

In the vehicle control system of the present disclosure, in the above configuration, when the predetermined condition is satisfied, the distance between the vehicle and the mobile terminal is estimated m times using at least an n-th electromagnetic wave of an n-th wavelength and an (n+1)-th electromagnetic wave of an (n+1)-th wavelength, n and m are natural numbers of 2 or more, and m increases as the estimated distance between the vehicle and the mobile terminal decreases.

According to the present disclosure, since the number of times of distance measurement increases as the distance between the vehicle and the mobile terminal decreases, the distance between the vehicle and the mobile terminal can be estimated with high accuracy as the mobile terminal approaches the vehicle.

In the vehicle control system of the present disclosure, in the above configuration, a first channel using the first electromagnetic wave of the first wavelength, a second channel using the second electromagnetic wave of the second wavelength, and a third channel using the third electromagnetic wave of the third wavelength are available.

According to the present disclosure, a rough distance between the vehicle and the mobile terminal can be estimated using the first channel, and when the estimated distance is smaller than the second distance threshold, the distance between the vehicle and the mobile terminal can be estimated with high accuracy using the second channel and the third channel.

In the vehicle control system of the present disclosure, in the above configuration, the second electromagnetic wave of the second wavelength and the third electromagnetic wave of the third wavelength are transmitted from the vehicle to the mobile terminal to estimate the distance between the vehicle and the mobile terminal, and/or the second electromagnetic wave of the second wavelength and the third electromagnetic wave of the third wavelength are transmitted from the mobile terminal to the vehicle to estimate the distance between the vehicle and the mobile terminal.

According to the present disclosure, it is possible to estimate the distance between the vehicle and the mobile terminal only by the vehicle, only by the mobile terminal, or by both the vehicle and the mobile terminal.

In the vehicle control system of the present disclosure, in the above configuration, when a vehicle control request is received from a main switch of the vehicle and when communication is performed between the vehicle and the mobile terminal using at least the first electromagnetic wave of the first wavelength and the predetermined condition is satisfied, the distance between the vehicle and the mobile terminal is estimated using at least the second electromagnetic wave of the second wavelength and the third electromagnetic wave of the third wavelength, and when the distance is smaller than the predetermined distance threshold, the operation of the vehicle is permitted.

According to the present disclosure, when the vehicle control request is received from the main switch of the vehicle and the distance between the vehicle and the mobile terminal is smaller than the predetermined distance threshold, the vehicle can be operated.

In the vehicle control system of the present disclosure, in the above configuration, the vehicle includes a vehicle control device including a housing, and the housing of the vehicle control device includes a holding portion held by the vehicle body of the vehicle.

According to the present disclosure, the vehicle control device can be held on the vehicle body of the vehicle.

A control method of the present disclosure is a control method executable by a vehicle control device to be mounted on a vehicle. The vehicle control device is capable of wireless communication with a mobile terminal using at least a first electromagnetic wave of a first wavelength, a second electromagnetic wave of a second wavelength, and a third electromagnetic wave of a third wavelength, and the second wavelength and the third wavelength are different from each other. When wireless communication is performed between the vehicle and the mobile terminal using at least the first electromagnetic wave of the first wavelength and a predetermined condition is satisfied, a distance between the vehicle and the mobile terminal is estimated using at least the second electromagnetic wave of the second wavelength and the third electromagnetic wave of the third wavelength, and when the distance is smaller than a predetermined distance threshold, an operation of the vehicle is permitted. The distance between the vehicle and the mobile terminal is estimated using at least the second electromagnetic wave of the second wavelength and the third electromagnetic wave of the third wavelength, and when the distance is greater than the predetermined distance threshold, the operation of the vehicle is not permitted.

According to the present disclosure, in the wireless communication between the vehicle and the mobile terminal using at least the first electromagnetic wave of the first wavelength, since the distance estimation using at least the second electromagnetic wave of the second wavelength and the third electromagnetic wave of the third wavelength is not performed until the predetermined condition is satisfied, the power used for the distance estimation can be reduced. In addition, since a component such as an acceleration sensor that increases the price is not used, power saving can be implemented at low costs, and the present invention can be applied to motorcycles that are constrained in terms of price and power consumption.

In the control method of the present disclosure, the distance between the vehicle and the mobile terminal is estimated based on at least a phase difference between the second electromagnetic wave of the second wavelength and the third electromagnetic wave of the third wavelength.

According to the present disclosure, the distance between the vehicle and the mobile terminal can be estimated with high accuracy by estimating the distance between the vehicle and the mobile terminal using at least the phase difference between the second electromagnetic wave and the third electromagnetic wave.

In the control method of the present disclosure, the distance is set as a first distance, the distance threshold is set as a first distance threshold, the predetermined condition is when a second distance estimated based on at least electric field strength and/or electromagnetic wave arrival time of the first electromagnetic wave of the first wavelength is smaller than a second distance threshold, and the second distance threshold is greater than the first distance threshold.

According to the present disclosure, since the distance estimation using at least the second electromagnetic wave of the second wavelength and the third electromagnetic wave of the third wavelength is not performed until the distance between the vehicle and the mobile terminal, that is, the second distance is smaller than the second distance threshold, the power used for the distance estimation can be reduced.

In the control method of the present disclosure, the distance is set as a first distance, the distance threshold is set as a first distance threshold, the predetermined condition is when a second distance estimated based on at least electric field strength and/or electromagnetic wave arrival time of the first electromagnetic wave of the first wavelength is smaller than a second distance threshold and when a change in the estimated second distance is greater than a predetermined change, and the second distance threshold is greater than the first distance threshold.

According to the present disclosure, since the distance estimation using at least the second electromagnetic wave of the second wavelength and the third electromagnetic wave of the third wavelength is not performed until the distance between the vehicle and the mobile terminal, that is, the second distance is smaller than the second distance threshold and the change in the second distance is greater than the predetermined change, the power used for the distance estimation can be reduced.

In the control method of the present disclosure, the distance is set as a first distance, and the predetermined condition is when a change in a second distance estimated based on at least electric field strength and/or electromagnetic wave arrival time of the first electromagnetic wave of the first wavelength is greater than a predetermined change.

According to the present disclosure, since the distance estimation using at least the second electromagnetic wave of the second wavelength and the third electromagnetic wave of the third wavelength is not performed until the distance between the vehicle and the mobile terminal, that is, the change in the second distance is greater than the predetermined change, the power used for the distance estimation can be reduced.

In the control method of the present disclosure, when the predetermined condition is satisfied, the distance between the vehicle and the mobile terminal is estimated m times using at least an n-th electromagnetic wave of an n-th wavelength and an (n+1)-th electromagnetic wave of an (n+1)-th wavelength, n and m are natural numbers of 2 or more, and m increases as the estimated distance between the vehicle and the mobile terminal decreases.

According to the present disclosure, since the number of times of distance measurement increases as the distance between the vehicle and the mobile terminal decreases, the distance between the vehicle and the mobile terminal can be estimated with high accuracy as the mobile terminal approaches the vehicle.

In the control method of the present disclosure, a first channel using the first electromagnetic wave of the first wavelength, a second channel using the second electromagnetic wave of the second wavelength, and a third channel using the third electromagnetic wave of the third wavelength are available.

According to the present disclosure, a rough distance between the vehicle and the mobile terminal can be estimated using the first channel, and when the estimated distance is smaller than the second distance threshold, the distance between the vehicle and the mobile terminal can be estimated with high accuracy using the second channel and the third channel.

In the control method of the present disclosure, the second electromagnetic wave of the second wavelength and the third electromagnetic wave of the third wavelength are transmitted from the vehicle to the mobile terminal to estimate the distance between the vehicle and the mobile terminal, and/or the second electromagnetic wave of the second wavelength and the third electromagnetic wave of the third wavelength are transmitted from the mobile terminal to the vehicle to estimate the distance between the vehicle and the mobile terminal.

According to the present disclosure, it is possible to estimate the distance between the vehicle and the mobile terminal only by the vehicle, only by the mobile terminal, or by both the vehicle and the mobile terminal.

In the control method of the present disclosure, when a vehicle control request is received from a main switch of the vehicle and when communication is performed between the vehicle and the mobile terminal using at least the first electromagnetic wave of the first wavelength and the predetermined condition is satisfied, the distance between the vehicle and the mobile terminal is estimated using at least the second electromagnetic wave of the second wavelength and the third electromagnetic wave of the third wavelength, and when the distance is smaller than the predetermined distance threshold, a control permission signal is transmitted to the vehicle.

According to the present disclosure, when the vehicle control request is received from the main switch of the vehicle and the distance between the vehicle and the mobile terminal is smaller than the predetermined distance threshold, the vehicle can be operated.

In the control method of the present disclosure, the vehicle control device includes a housing, and the housing of the vehicle control device includes a holding portion held by a vehicle body of the vehicle.

According to the present disclosure, the vehicle control device can be held on the vehicle body of the vehicle.

According to the present disclosure, power saving can be implemented at a price applicable to motorcycles.

### BRIEF DESCRIPTION OF DRAWINGS

FIG. 1 is a block diagram showing a schematic configuration of a vehicle control system according to an embodiment;

FIG. 2 is a side view showing an appearance of a vehicle constituting the vehicle control system of the embodiment;

FIG. 3 is a perspective view showing an appearance of a vehicle ECU constituting the vehicle control system of the embodiment;

FIG. 4 is a diagram illustrating distance estimation of the vehicle ECU constituting the vehicle control system of the embodiment;

FIG. 5 is a diagram illustrating the distance estimation of the vehicle ECU constituting the vehicle control system of the embodiment;

FIG. 6 is a diagram illustrating the distance estimation of the vehicle ECU constituting the vehicle control system of the embodiment;

FIG. 7 is a diagram illustrating the distance estimation of the vehicle ECU constituting the vehicle control system of the embodiment;

FIG. 8 is a diagram illustrating the distance estimation of the vehicle ECU constituting the vehicle control system of the embodiment;

FIG. 9 is a sequence diagram showing a process between the vehicle ECU and an electronic key constituting the vehicle control system of the embodiment;

FIG. 10 is a sequence diagram showing a process between the vehicle ECU and the electronic key constituting the vehicle control system of the embodiment;

FIG. 11 is a sequence diagram showing a process between the vehicle ECU and the electronic key constituting the vehicle control system of the embodiment;

FIG. 12 is a flowchart illustrating an operation of the vehicle ECU constituting the vehicle control system of the embodiment; and

FIG. 13 is a block diagram showing a schematic configuration of a smartphone that can be applied to the vehicle control system of the embodiment and has a distance detection function.

### DESCRIPTION OF EMBODIMENTS

Hereinafter, an embodiment (hereinafter, referred to as “present embodiment”) of a vehicle control system according to the present disclosure will be described in detail with reference to the drawings as appropriate. However, unnecessarily detailed description may be omitted. For example, detailed description of well-known matters and redundant description of substantially the same configuration may be omitted. This is to avoid the following description from being unnecessarily redundant and facilitate understanding of those skilled in the art. The accompanying drawings and the following description are provided for those skilled in the art to fully understand the present disclosure, and are not intended to limit the subject matters described in the claims.

Hereinafter, a preferred present embodiment for carrying out the present disclosure will be described in detail with reference to the drawings.

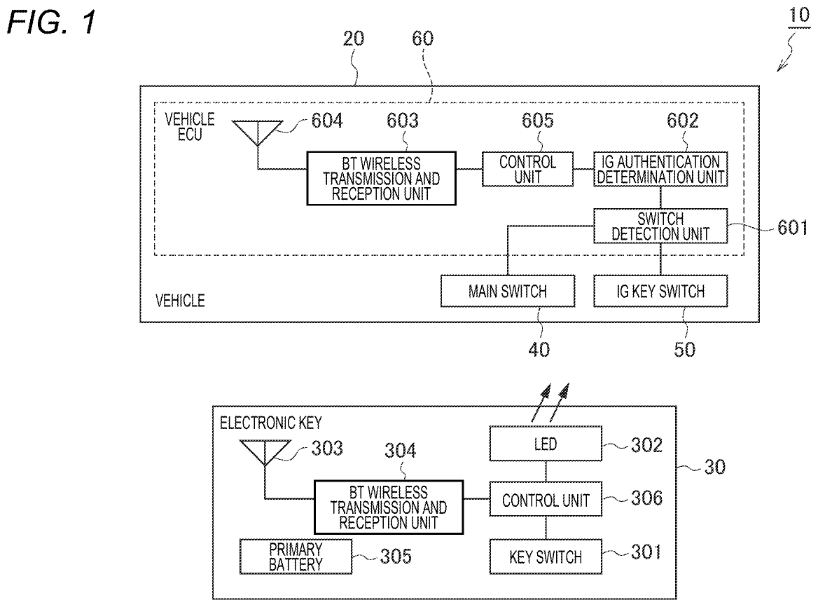

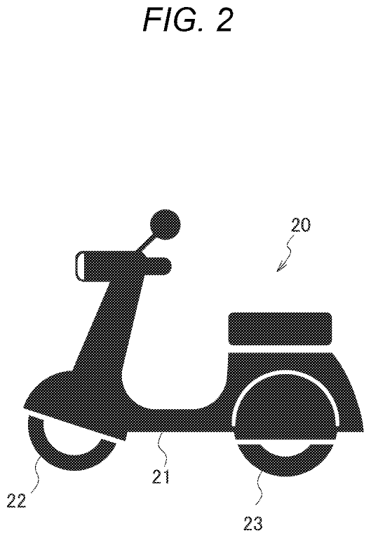

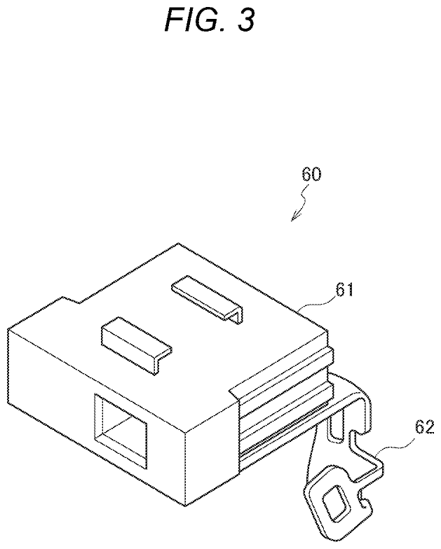

Hereinafter, the vehicle control system of the present embodiment will be described with reference to the drawings. FIG. 1 is a block diagram showing a schematic configuration of a vehicle control system 10 of the present embodiment. FIG. 2 is a side view showing an appearance of a vehicle 20 constituting the vehicle control system 10 of the present embodiment. FIG. 3 is a perspective view showing an appearance of a vehicle ECU 60, which is a vehicle control device constituting the vehicle control system 10 of the present embodiment. In FIGS. 1 to 3, the vehicle control system 10 of the present embodiment includes the vehicle 20 of a motorcycle and an electronic key (mobile terminal) 30 possessed by a user of the vehicle 20. The vehicle 20 includes a vehicle body 21, and a front wheel (first wheel) 22 and a rear wheel (second wheel) 23 coupled to the vehicle body 21. The vehicle 20 is not limited to a two-wheeled vehicle, and may be a single-wheeled vehicle or a vehicle having three or more wheels. The vehicle ECU 60 includes a box-shaped housing 61 and a vehicle holding portion 62 for holding the housing 61 in the vehicle 20. The electronic key 30 includes a box-shaped housing having a shape and size suitable for carrying around. The electronic key 30 is registered in advance in the vehicle ECU 60 so as to be paired with the vehicle ECU 60.

In FIG. 1, the vehicle 20 includes a main switch 40, an IG KEY switch 50, and the vehicle ECU 60. The main switch 40 is a switch for requesting vehicle control. The IG KEY switch 50 is a switch for starting an engine of the vehicle 20 and operating other electrical systems. The main switch 40 and the IG KEY switch 50 in the vehicle 20 are manually operated by a hand of an operator. The vehicle ECU 60 includes a switch detection unit 601, an IG authentication determination unit 602, a BT wireless transmission and reception unit 603, an antenna 604, and a control unit 605. The switch detection unit 601 detects operations of the main switch 40 and the IG KEY switch 50. When the switch detection unit 601 detects the operation of the IG KEY switch 50, the IG authentication determination unit 602 performs IG authentication determination.

The BT wireless transmission and reception unit 603 transmits and receives electromagnetic waves of a wireless communication scheme conforming to Bluetooth. Bluetooth adopts a communication system that performs periodic communication, and has a frequency of about 2.4 GHz and a communication distance of about 100 m. The BT wireless transmission and reception unit 603 performs wireless communication with the electronic key via the antenna 604. The BT wireless transmission and reception unit 603 can transmit and receive electromagnetic waves of at least three channels. For example, the BT wireless transmission and reception unit 603 can transmit and receive a first electromagnetic wave of a first wavelength in a first channel, a second electromagnetic wave of a second wavelength in a second channel, and a third electromagnetic wave of a third wavelength in a third channel. Here, among the first to third wavelengths, the first wavelength and the second wavelength may be the same, and the first wavelength and the third wavelength may be the same. However, as will be described below, since a distance between the vehicle 20 and the electronic key 30 is estimated based on a phase difference between the second wavelength and the third wavelength, the second wavelength and the third wavelength are different from each other. When the number of channels of the BT wireless transmission and reception unit 603 is “4” or more, the channels may not be consecutive “3” channels, but may be a combination of discrete channels. For example, when the number of channels is “10”, a combination of channels “1”, “5”, and “10” may be used. The number of wavelengths used in a first distance estimation method for estimating a first distance to be described later may be smaller than the number of wavelengths used in a second distance estimation method for estimating a second distance to be described later. That is, the first electromagnetic wave of the first wavelength may have a smaller number of wavelengths than the second electromagnetic wave of the second wavelength and the third electromagnetic wave of the third wavelength.

The control unit 605 controls the BT wireless transmission and reception unit 603 and the like, and includes a CPU (central processing unit) (not shown), a ROM (read only memory) (not shown) storing a program for controlling the CPU, and a RAM (random access memory) (not shown) used for an operation of the CPU. In the control of the BT wireless transmission and reception unit 603 and the like, when there is a determination result of the IG authentication determination unit 602, a vehicle control request by the operation of the main switch 40, or the like, the control unit 605 acquires the determination result or the request.

The control unit 605 performs wireless communication with the electronic key 30 using the first channel using the first electromagnetic wave of the first wavelength, and estimates the distance to the electronic key 30 (referred to as “second distance”) based on electric field strength (RSSI) and/or electromagnetic wave arrival time (ToF) of the first electromagnetic wave (first distance estimation method). The RSSI is used to control a transmission range in wireless communication such as wireless LAN or Bluetooth. The ToF measures a distance to an object based on the time required for reflected light to return after irradiating the object with light (electromagnetic wave).

When the second distance estimated using the electric field strength and/or the electromagnetic wave arrival time is smaller than a predetermined threshold (referred to as a “second distance threshold (vehicle distant threshold)”), the control unit 605 estimates the distance between the vehicle 20 and the electronic key 30 using the second channel using the second electromagnetic wave of the second wavelength and the third channel using the third electromagnetic wave of the third wavelength (the second distance estimation method). This distance estimation uses the phase difference between the second wavelength and the third wavelength. The second distance threshold (vehicle distant threshold) may be determined based on the actually measured data, and is set between 10 m to 15 m, for example.

When determining that the distance to the electronic key 30 estimated using the phase difference (referred to as “first distance”) is smaller than a predetermined distance threshold (referred to as “first distance threshold (vehicle proximity threshold)”), the control unit 605 permits an operation of the vehicle 20, and when determining that the distance is greater than the predetermined distance threshold, the control unit 605 does not permit the operation of the vehicle 20. The first distance threshold (vehicle proximity threshold) may be determined based on the actually measured data, and is set between 2 m to 3 m, for example. The control of the control unit 605 will be described later in detail.

The electronic key 30 includes a key switch 301, a light emitting diode (LED) 302, an antenna 303, a BT wireless transmission and reception unit 304, a primary battery 305, and a control unit 306. The key switch 301 is a switch for unlocking the vehicle 20. The LED 302 notifies an operation of the key switch 301, and is turned on when the key switch 301 is operated.

The BT wireless transmission and reception unit 304 transmits and receives electromagnetic waves of a wireless communication scheme conforming to Bluetooth with the vehicle ECU 60. The BT wireless transmission and reception unit 304 performs wireless communication with the vehicle ECU 60 via the antenna 303. Similarly to the BT wireless transmission and reception unit 603 of the vehicle ECU 60, the BT wireless transmission and reception unit 304 can transmit and receive electromagnetic waves of at least three channels. For example, the BT wireless transmission and reception unit 603 can transmit and receive a first electromagnetic wave of a first wavelength in a first channel, a second electromagnetic wave of a second wavelength in a second channel, and a third electromagnetic wave of a third wavelength in a third channel. Among the first to third wavelengths, the first wavelength and the second wavelength may be the same, and the first wavelength and the third wavelength may be the same. However, the second wavelength and the third wavelength are different from each other. When the number of channels of the BT wireless transmission and reception unit 304 is “4” or more, the channels may not be consecutive “3” channels, but may be a combination of discrete channels. For example, when the number of channels is “10”, a combination of channels “1”, “5”, and “10” may be used.

The primary battery 305 supplies power to each unit of the electronic key 30. The control unit 306 acquires a switch signal when the key switch 301 is operated, and controls the LED 302 and the BT wireless transmission and reception unit 304 respectively. The control unit 306 includes a CPU (not shown), a ROM (not shown) storing a program for controlling the CPU, and a RAM (not shown) used for the operation of the CPU.

Next, the control of the control unit 605 of the vehicle ECU 60 will be described in detail with reference to the drawings.

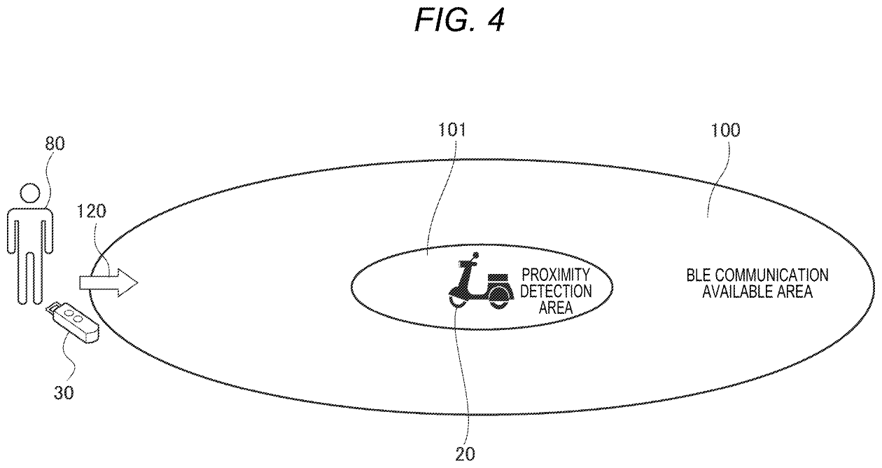

FIGS. 4 to 8 are diagrams illustrating the distance estimation of the vehicle ECU 60. The vehicle ECU 60 performs the following distance estimation. The vehicle ECU 60 mounted on the vehicle 20 communicates with the electronic key 30 in a BLE communication available area 100. In a proximity detection area 101 in the BLE communication available area 100, when the electronic key 30 is present, the vehicle ECU 60 permits the operation of the vehicle 20. It is assumed that the electronic key 30 is possessed by a user 80 of the vehicle 20.

In FIG. 4, first, when the electronic key 30 registered in advance enters the BLE communication available area 100, the vehicle ECU 60 connects with the electronic key 30 according to the Bluetooth communication standard. An arrow 120 indicates that the electronic key 30 is moving and a direction thereof. When the vehicle ECU 60 connects with the electronic key 30 entering the BLE communication available area 100, the vehicle ECU 60 acquires the electric field strength (RSSI) and/or the electromagnetic wave arrival time (ToF) in the Bluetooth periodic communication. To obtain the electric field strength and the electromagnetic wave arrival time, at least the first channel using the first electromagnetic wave is used. The vehicle ECU 60 detects an approximate distance to the electronic key 30 based on the acquired electric field strength and/or the electromagnetic wave arrival time.

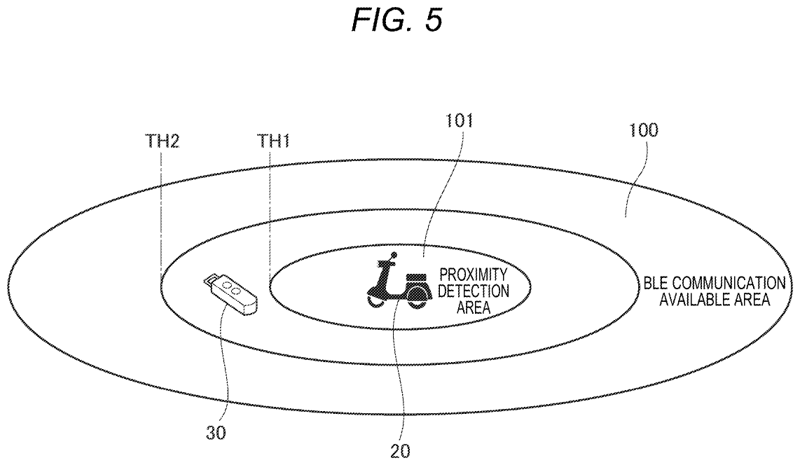

When the vehicle ECU 60 detects the distance to the electronic key 30, and when a change in the distance with respect to the previously detected distance is equal to or less than a threshold of a predetermined temporal change (a temporal change in the electric field strength is equal to or less than the threshold of the predetermined temporal change), the vehicle ECU 60 determines that the electronic key 30 is not moving. If the electronic key 30 is in the BLE communication available area 100 but is not moving, the vehicle ECU 60 does not estimate the distance to the electronic key 30 using the phase difference. FIG. 5 shows that the electronic key 30 is not moving.

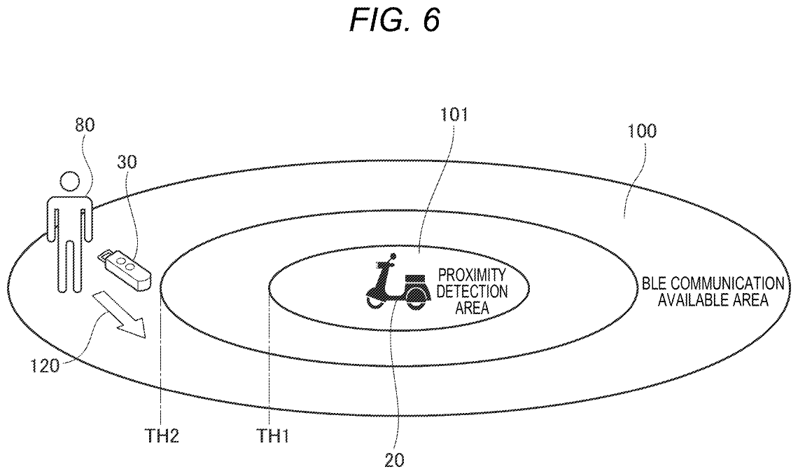

When the approximate distance to the electronic key 30 is equal to or greater than the predetermined threshold, the vehicle ECU 60 determines that the electronic key 30 is far from the vehicle 20 and does not perform the distance estimation using the phase difference. That is, even if the electronic key 30 is within the BLE communication available area 100, if the electronic key 30 is outside a second distance threshold (vehicle distant threshold) TH2, the vehicle ECU 60 does not perform the distance estimation using the phase difference. FIG. 6 shows that the electronic key 30 is moving outside the second distance threshold TH2.

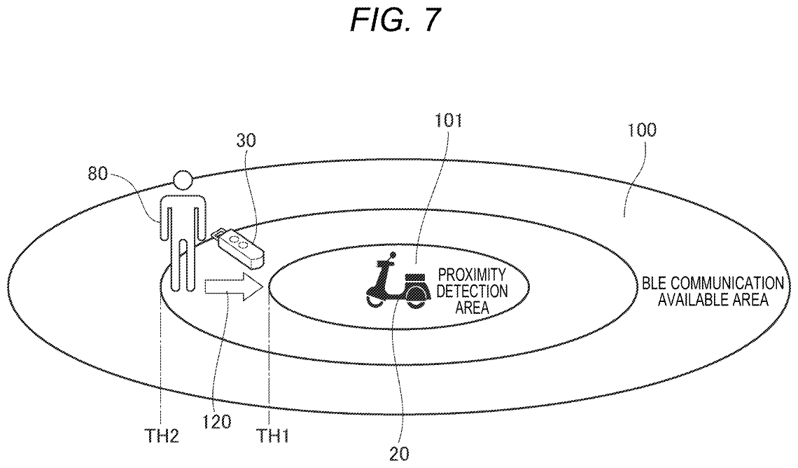

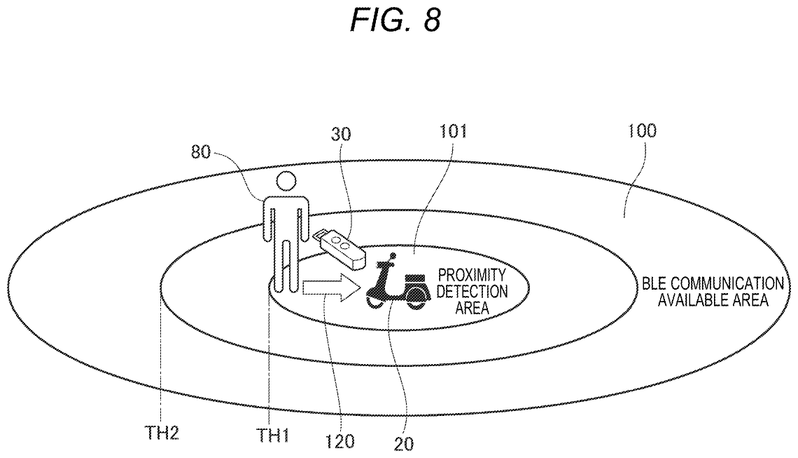

When the vehicle ECU 60 detects the approximate distance to the electronic key 30 based on the electric field strength and/or the electromagnetic wave arrival time, and when the change in the distance with respect to the previously detected distance is equal to or greater than the threshold of the predetermined temporal change (the temporal change in the electric field strength is equal to or greater than the threshold of the predetermined temporal change) and the distance is equal to or less than the second distance threshold (vehicle distant threshold) TH2, the vehicle ECU 60 determines that the electronic key 30 is moving and performs the distance estimation using the phase difference. The distance estimation using the phase difference is continuously performed in the proximity detection area 101. FIG. 7 shows that the electronic key 30 is moving within the second distance threshold TH2. FIG. 8 shows that the electronic key 30 is moving within a first distance threshold TH1 (vehicle proximity threshold) smaller than the second distance threshold TH2, that is, in the proximity detection area 101. Whether the electronic key 30 is moving may be determined based on whether a change in the distance to the electronic key 30 is equal to or greater than the threshold of the predetermined temporal change (the temporal change in the electric field strength is equal to or greater than the threshold of the predetermined temporal change). When the change in the distance to the electronic key 30 is equal to or greater than the threshold of the predetermined temporal change, the electronic key 30 is moving, and when the change is equal to or less than the threshold, the electronic key 30 is not moving.

The vehicle ECU 60 estimates the distance between the vehicle 20 and the electronic key 30 a plurality of times using the phase difference between the second electromagnetic wave of the second wavelength and the third electromagnetic wave of the third wavelength, and the number of times of estimation is increased as the estimated distance between the vehicle 20 and the electronic key 30 decreases. To estimate the distance between the vehicle 20 and the electronic key 30, it is necessary to use at least two electromagnetic waves (of different wavelengths), and three or more electromagnetic waves (of different wavelengths) may be used. A relation between the electromagnetic wave and the number of times of distance estimation for estimating the distance using the phase difference is that “The distance between the vehicle 20 and the electronic key 30 is estimated m times using at least an n-th electromagnetic wave of an n-th wavelength and an (n+1)-th electromagnetic wave of an (n+1)-th wavelength. n and m are natural numbers of 2 or more, and m increases as an estimated distance between the vehicle 20 and the electronic key 30 decreases”.

The number of times of communication between the vehicle 20 and the electronic key 30 may be determined based on the actually measured data, and starts from 20 times and is 75 times at maximum, for example. In the vicinity of the vehicle 20, the number of times of communication can ensure the highest accuracy. By increasing the number of times of estimating the distance between the vehicle 20 and the electronic key 30 as the distance decreases, the distance between the vehicle 20 and the electronic key 30 can be estimated with high accuracy as the electronic key 30 approaches the vehicle 20.

Next, an operation of the vehicle control system 10 of the present embodiment will be described in detail.

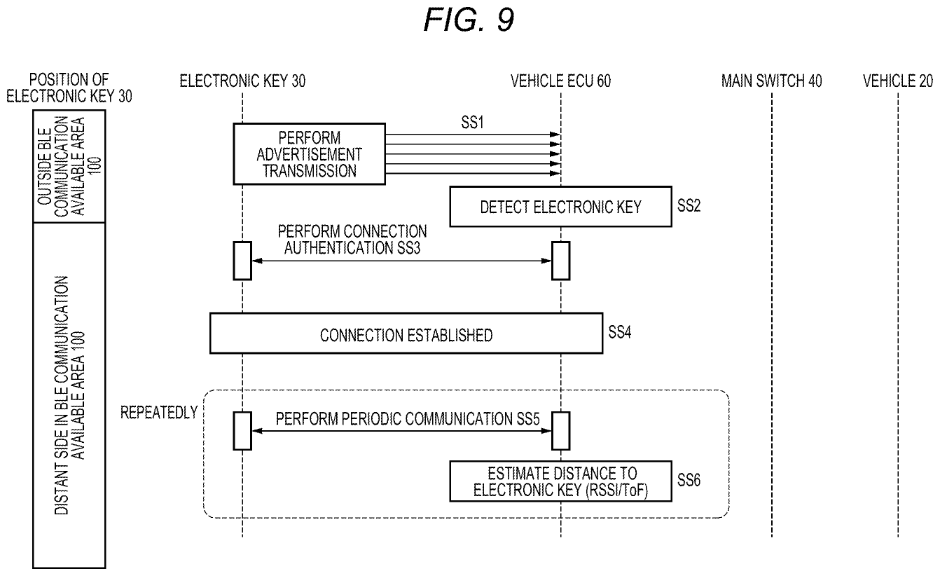

FIGS. 9 to 11 are sequence diagrams showing a process between the vehicle ECU 60 and the electronic key 30 constituting the vehicle control system 10.

As shown in FIG. 9, outside the BLE communication available area 100, the electronic key 30 performs advertisement transmission at predetermined intervals (SS1). Then, when the electronic key 30 enters the BLE communication available area 100, the vehicle ECU 60 detects the electronic key 30 by receiving the advertisement transmission from the electronic key 30 (SS2). When the vehicle ECU 60 detects the electronic key 30, the vehicle ECU 60 performs connection authentication with the electronic key 30 (SS3). When the connection authentication with the electronic key 30 is established (SS4), the vehicle ECU repeatedly performs periodic communication with the electronic key 30 (SS5). Every time the vehicle ECU 60 performs periodic communication with the electronic key 30, the vehicle ECU 60 estimates the approximate distance to the electronic key 30 based on the electric field strength and/or the electromagnetic wave arrival time (SS6).

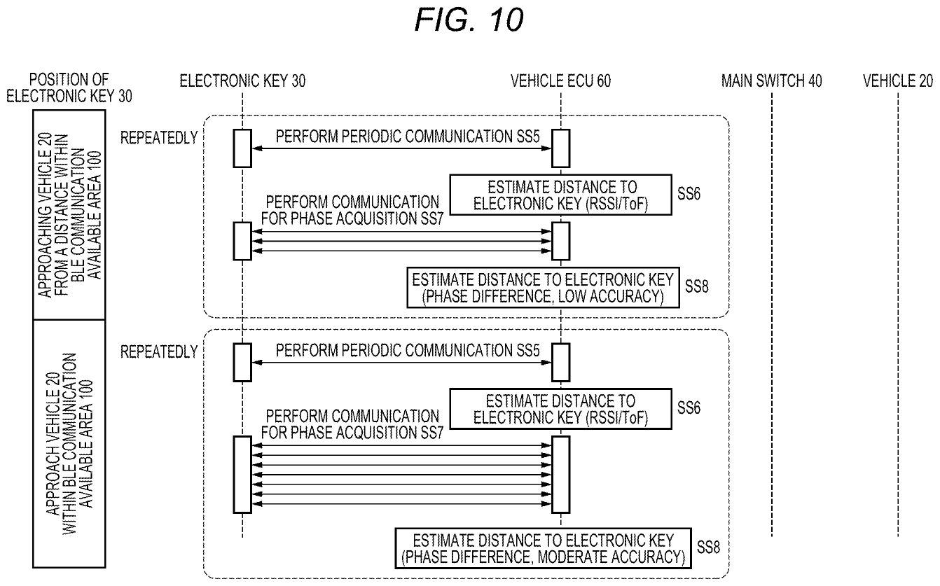

In FIG. 10, when the electronic key 30 is approaching the vehicle 20 from a distance in the BLE communication available area 100, the vehicle ECU 60 performs periodic communication with the electronic key 30 (SS5), acquires the electric field strength and/or the electromagnetic wave arrival time, and estimates the distance to the electronic key 30 (SS6). At this time, if the distance is smaller than the second distance threshold TH2, the vehicle ECU 60 performs communication for phase acquisition with the electronic key 30 (SS7), and estimates the distance to the electronic key 30 based on the phase difference between the second electromagnetic wave of the second wavelength and the third electromagnetic wave of the third wavelength (SS8). In this case, since the electronic key 30 just enters the BLE communication available area 100 and is approaching the vehicle 20 from the second distance threshold TH2, the number of times of estimation is small and the accuracy of distance estimation is low.

The vehicle ECU 60 repeatedly performs the above processing, increases the number of times of communication for phase acquisition as the electronic key 30 approaches the vehicle 20, and increases the accuracy of distance estimation with respect to the electronic key 30. At this time, the electronic key 30 is approaching the vehicle 20, the number of times of communication for phase acquisition increases, and the accuracy of distance estimation is moderate. The vehicle ECU 60 repeatedly performs the above processing, and increases the number of times of communication for phase acquisition as the distance to the electronic key 30 decreases.

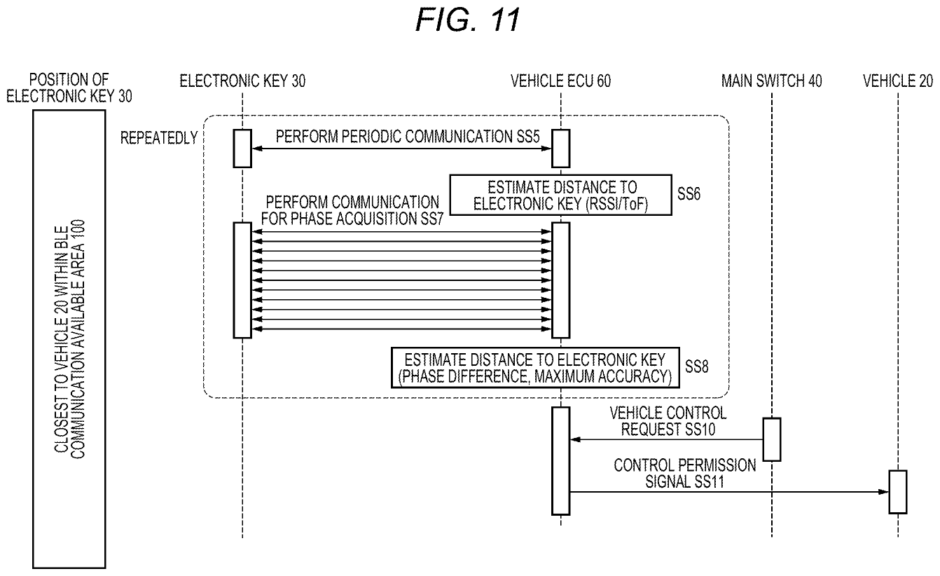

In FIG. 11, when the electronic key 30 is closest to the vehicle 20 in the BLE communication available area 100, the vehicle ECU 60 further increases the number of times of communication for phase acquisition and estimates the distance to the electronic key 30 (SS8). At this time, since the electronic key 30 is further closer to the vehicle 20, the number of times of estimation is further increased and the accuracy of distance estimation is maximized. The vehicle ECU 60 repeatedly performs the above processing, and when the vehicle ECU 60 receives a vehicle control request from the main switch 40 of the vehicle 20 while repeatedly performing the above processing (SS10), the vehicle ECU 60 outputs a control permission signal to the vehicle 20 (SS11) to permit the operation of the vehicle 20.

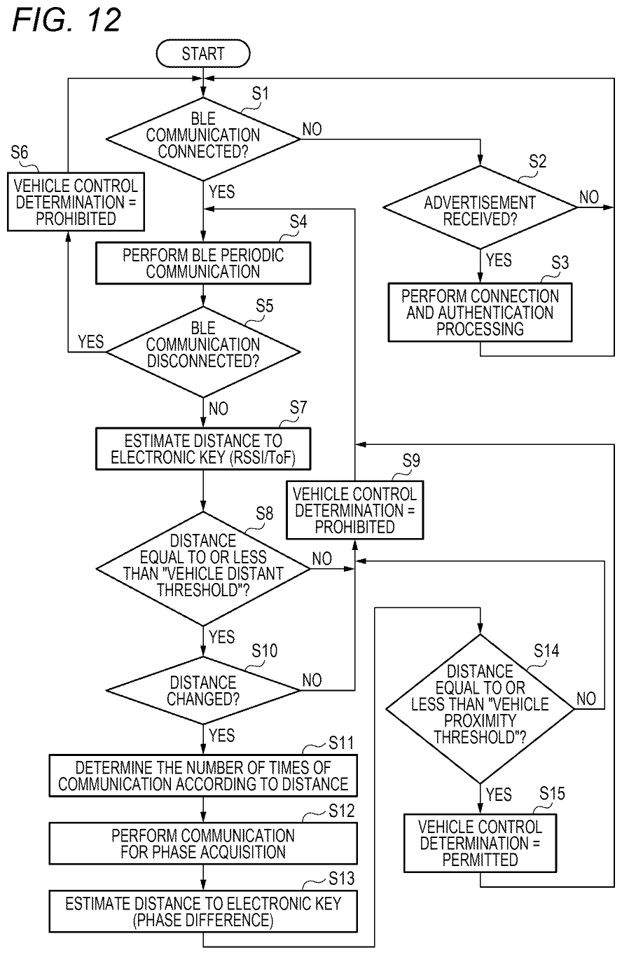

FIG. 12 is a flowchart illustrating an operation of the vehicle ECU 60 constituting the vehicle control system 10. Although a subject of the operation of the vehicle ECU 60 is the control unit 605, the vehicle ECU 60 will be described as the subject. As illustrated, the vehicle ECU 60 performs BLE communication with the electronic key 30 to determine whether a connection is established (step S1). When determining that the BLE communication connection with the electronic key 30 is not in progress (if it is determined as “NO” in step S1), the vehicle ECU 60 determines whether an advertisement is received (step S2). When determining that no advertisement is received (if it is determined as “NO” in step S2), the vehicle ECU 60 returns to the processing of step S1. When determining that an advertisement is received (if it is determined as “YES in step S2), the vehicle ECU 60 performs connection and authentication processing with the electronic key 30 (step S3) and then returns to step S1.

When determining in step S1 that the electronic key 30 is in the BLE communication connection (if it is determined as “YES” in step S1), the vehicle ECU 60 performs the BLE periodic communication with the electronic key 30 (step S4). The vehicle ECU 60 determines whether the BLE communication is disconnected while performing the BLE periodic communication (step S5). When determining that the BLE communication is disconnected (if it is determined as “YES” in step S5), the vehicle ECU 60 prohibits vehicle control determination, that is, does not permit the operation of the vehicle 20 (step S6), and returns to step S1.

When determining in step S5 that the BLE communication with the electronic key 30 is not disconnected (if it is determined as “NO in step S5), the vehicle ECU 60 estimates the distance to the electronic key 30 based on the electric field strength (RSSI) and/or the electromagnetic wave arrival time (ToF) (step S7). Then, the vehicle ECU 60 determines whether the distance to the electronic key 30 estimated based on the electric field strength and/or the electromagnetic wave arrival time is equal to or less than the “vehicle distant threshold” (step S8). That is, the vehicle ECU 60 determines whether the distance is equal to or less than the second distance threshold TH2 shown in FIGS. 5 to 8.

When determining that the distance to the electronic key 30 is greater than the “vehicle distant threshold” (if it is determined as “NO” in step S8), the vehicle ECU 60 prohibits the vehicle control determination, that is, does not permit the operation of the vehicle 20 (step S9), and returns to step S4. That is, the vehicle ECU 60 determines that the electronic key 30 is outside the second distance threshold TH2 of the BLE communication available area 100, and does not permit the operation of the vehicle 20.

When determining in step S8 that the distance to the electronic key 30 is equal to or less than the “vehicle distant threshold” (if it is determined as “YES” in step S8), the vehicle ECU 60 determines whether there is a change in the distance to the electronic key 30 to determine whether the electronic key 30 is moving (step S10). When determining that there is no change in the distance to the electronic key 30, that is, when determining that the electronic key 30 is not moving, the vehicle ECU 60 prohibits the vehicle control determination, that is, does not permit the operation of the vehicle 20 (step S9), and returns to step S4.

When determining in step S10 that there is a change in the distance to the electronic key 30, that is, when determining that the electronic key 30 is moving, the vehicle ECU 60 determines the number of times of communication corresponding to the distance to the electronic key 30 (step S11). After determining the number of times of communication corresponding to the distance to the electronic key 30, the vehicle ECU 60 performs communication for phase acquisition with the electronic key 30 for the number of times of communication (step S12). Then, the vehicle ECU 60 performs the communication for phase acquisition for the determined number of times of communication, and estimates the distance to the electronic key 30 using the phase difference (step S13). Next, the vehicle ECU 60 determines whether the estimated distance to the electronic key 30 is equal to or less than the “vehicle proximity threshold” (step S14). That is, the vehicle ECU 60 determines whether the distance is equal to or less than the first distance threshold TH1 shown in FIGS. 5 to 8.

When determining that the distance to the electronic key 30 is greater than the “vehicle proximity threshold” (if it is determined as “NO” in step S14), the vehicle ECU 60 proceeds to step S9. That is, the vehicle ECU 60 determines that the electronic key 30 is outside the first distance threshold TH1 of the BLE communication available area 100, and does not permit the operation of the vehicle 20. When determining that the distance to the electronic key 30 is equal to or less than the “vehicle proximity threshold” (if it is determined as “YES” in step S14), the vehicle ECU 60 permits the vehicle control determination, that is, permits the operation of the vehicle 20 (step S15). That is, when the electronic key 30 is inside the first distance threshold TH1 of the BLE communication available area 100, the vehicle ECU 60 permits the operation of the vehicle 20. After permitting the operation of the vehicle 20, the vehicle ECU 60 returns to step S4.

As described above, the vehicle control system 10 of the present embodiment performs wireless communication conforming to Bluetooth using at least a first electromagnetic wave of a first wavelength between the vehicle 20 and the electronic key 30, estimates a second distance based on at least electric field strength and/or electromagnetic wave arrival time of the first electromagnetic wave of the first wavelength, and does not perform distance estimation based on at least a phase difference between a second electromagnetic wave of a second wavelength and a third electromagnetic wave of a third wavelength until a condition that the estimated second distance is smaller than the second distance threshold TH2 and a change in the estimated second distance is greater than a predetermined change is satisfied. Therefore, the power used for the distance estimation can be reduced. In addition, since a component such as an acceleration sensor that increases the price is not used, power saving can be implemented at low costs, and the present invention can be applied to motorcycles that are constrained in terms of price and power consumption.

In the vehicle control system 10 of the present embodiment, in addition to using the first electromagnetic wave of the first wavelength for the distance estimation using the electric field strength and/or the electromagnetic wave arrival time, for example, the second electromagnetic wave of the second wavelength or the third electromagnetic wave of the third wavelength may be used. That is, to estimate a rough distance between the vehicle 20 and the electronic key 30, an electromagnetic wave of a wavelength other than the first electromagnetic wave of the first wavelength may be used.

In the vehicle control system 10 of the present embodiment, in addition to using the second electromagnetic wave of the second wavelength and the third electromagnetic wave of the third wavelength in the distance estimation based on the phase difference, the first electromagnetic wave of the first wavelength and the second electromagnetic wave of the second wavelength may be used, or the first electromagnetic wave of the first wavelength and the third electromagnetic wave of the third wavelength may be used.

In the vehicle control system 10 of the present embodiment, when the number of channels of the BT wireless transmission and reception unit 603 is “4” or more, three or more electromagnetic waves may be used to estimate the distance between the vehicle 20 and the electronic key 30 based on the phase difference.

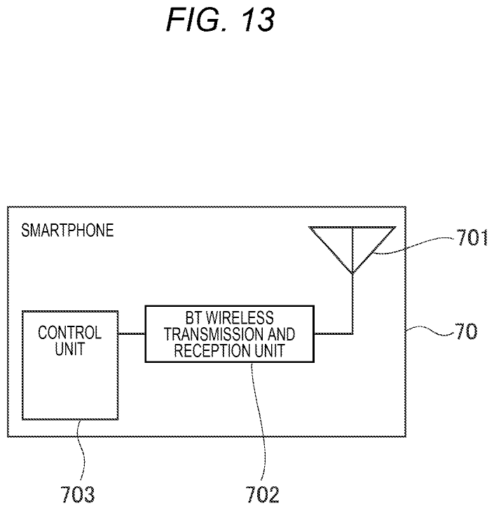

In the vehicle control system 10 of the present embodiment, the vehicle 20 is combined with the electronic key 30, but the vehicle 20 may be combined with a smartphone instead of the electronic key 30. FIG. 13 is a block diagram showing a schematic configuration of a smartphone 70. As illustrated, the smartphone 70 includes an antenna 701, a BT wireless transmission and reception unit 702, and a control unit 703. The BT wireless transmission and reception unit 702 performs wireless communication conforming to Bluetooth with the vehicle ECU 60. The control unit 703 controls the BT wireless transmission and reception unit 702 and the like. The control unit 703 includes a CPU (not shown), a ROM (not shown) storing a program for controlling the CPU, and a RAM (not shown) used for an operation of the CPU, and has a distance estimation function substantially equivalent to that of the control unit 306 of the electronic key 30.

In the vehicle control system 10 of the present embodiment, the distance between the vehicle 20 and the electronic key 30 is estimated by the vehicle 20, but the distance may be estimated by the electronic key 30, or may be estimated by both the vehicle 20 and the electronic key 30. When the electronic key 30 estimates the distance, the electronic key 30 transmits the second electromagnetic wave of the second wavelength and the third electromagnetic wave of the third wavelength to the vehicle 20, and estimates the distance between the vehicle 20 and the electronic key 30.

In the vehicle control system 10 of the present embodiment, electromagnetic waves are used for the wireless communication between the vehicle 20 and the electronic key 30, but light (which is also a kind of electromagnetic wave) may be used.

Although the present disclosure has been described in detail with reference to a specific embodiment, it is obvious to those skilled in the art that various changes and modifications can be made without departing from the spirit and scope of the present disclosure.

The present application is based on a Japan patent application (Japanese Patent Application No. 2021-055590) filed on Mar. 29, 2021, and the contents thereof are incorporated herein by reference.

### INDUSTRIAL APPLICABILITY

The vehicle control system of the present disclosure is useful for a vehicle such as a motorcycle.

### REFERENCE SIGNS LIST

10 vehicle control system
20 vehicle
21 vehicle body
22 front wheel
23 rear wheel
30 electronic key
40 main switch
50 IG KEY switch
60 vehicle ECU
61 housing
62 vehicle holding portion
70 smartphone
80 user
100 BLE communication available area
101 proximity detection area
301 key switch
302 LED
303, 604, 701 antenna
304, 603, 702 BT wireless transmission and reception unit
305 primary battery
306, 605, 703 control unit
601 switch detection unit
602 IG authentication determination unit

What is claimed is:

1. A vehicle control system comprising:
a vehicle; and
a mobile terminal, wherein
the vehicle includes at least a vehicle body and a first wheel and a second wheel coupled to the vehicle body, and is movable by the first wheel and the second wheel,
the mobile terminal and the vehicle are capable of wireless communication using at least a first electromagnetic wave of a first wavelength, a second electromagnetic wave of a second wavelength, and a third electromagnetic wave of a third wavelength,
when wireless communication is performed between the vehicle and the mobile terminal using at least the first electromagnetic wave of the first wavelength and a predetermined condition is satisfied, a distance between the vehicle and the mobile terminal is estimated using at least the second electromagnetic wave of the second wavelength and the third electromagnetic wave of the third wavelength, and when the distance is smaller than a predetermined distance threshold, an operation of the vehicle is permitted,
the distance between the vehicle and the mobile terminal is estimated using at least the second electromagnetic wave of the second wavelength and the third electromagnetic wave of the third wavelength, and when the distance is greater than the predetermined distance threshold, the operation of the vehicle is not permitted, and
the second wavelength and the third wavelength are different from each other.

2. The vehicle control system according to claim 1, wherein
the distance between the vehicle and the mobile terminal is estimated based on at least a phase difference between the second electromagnetic wave of the second wavelength and the third electromagnetic wave of the third wavelength.

3. The vehicle control system according to claim 1, wherein
the distance is set as a first distance,
the distance threshold is set as a first distance threshold,
the predetermined condition is a case that a second distance estimated based on at least electric field strength and/or electromagnetic wave arrival time of the first electromagnetic wave of the first wavelength is smaller than a second distance threshold, and
the second distance threshold is greater than the first distance threshold.

4. The vehicle control system according to claim 1, wherein
the distance is set as a first distance,
the distance threshold is set as a first distance threshold,
the predetermined condition is a case that a second distance estimated based on at least electric field strength and/or electromagnetic wave arrival time of the first electromagnetic wave of the first wavelength is smaller than a second distance threshold and a case that a change in the estimated second distance is greater than a predetermined change, and
the second distance threshold is greater than the first distance threshold.

5. The vehicle control system according to claim 1, wherein
the distance is set as a first distance, and
the predetermined condition is a case that a change in a second distance estimated based on at least electric field strength and/or electromagnetic wave arrival time of the first electromagnetic wave of the first wavelength is greater than a predetermined change.

6. The vehicle control system according to claim 1, wherein
when the predetermined condition is satisfied, the distance between the vehicle and the mobile terminal is estimated m times using at least an n-th electromagnetic wave of an n-th wavelength and an (n+1)-th electromagnetic wave of an (n+1)-th wavelength,
wherein, n and m are natural numbers of 2 or more, and
m increases as the estimated distance between the vehicle and the mobile terminal decreases.

7. The vehicle control system according to claim 1, wherein
a first channel using the first electromagnetic wave of the first wavelength, a second channel using the second electromagnetic wave of the second wavelength, and a third channel using the third electromagnetic wave of the third wavelength are available.

8. The vehicle control system according to claim 1, wherein
the second electromagnetic wave of the second wavelength and the third electromagnetic wave of the third wavelength are transmitted from the vehicle to the mobile terminal to estimate the distance between the vehicle and the mobile terminal, and/or
the second electromagnetic wave of the second wavelength and the third electromagnetic wave of the third wavelength are transmitted from the mobile terminal to the vehicle to estimate the distance between the vehicle and the mobile terminal.

9. The vehicle control system according to claim 1, wherein
when a vehicle control request is received from a main switch of the vehicle and when communication is performed between the vehicle and the mobile terminal using at least the first electromagnetic wave of the first wavelength and the predetermined condition is satisfied, the distance between the vehicle and the mobile terminal is estimated using at least the second electromagnetic wave of the second wavelength and the third electromagnetic wave of the third wavelength, and when the distance is smaller than the predetermined distance threshold, the operation of the vehicle is permitted.

10. The vehicle control system according to claim 1, wherein
the vehicle includes a vehicle control device having a housing, and
the housing of the vehicle control device includes a holding portion held by the vehicle body of the vehicle.

11. A control method executable by a vehicle control device to be mounted on a vehicle, the vehicle control device configured of being capable of wireless communication with a mobile terminal using at least a first electromagnetic wave of a first wavelength, a second electromagnetic wave of a second wavelength, and a third electromagnetic wave of a third wavelength, the second wavelength and the third wavelength being different from each other, the method comprising:
when wireless communication is performed between the vehicle and the mobile terminal using at least the first electromagnetic wave of the first wavelength and a predetermined condition is satisfied, estimating a distance between the vehicle and the mobile terminal using at least the second electromagnetic wave of the second wavelength and the third electromagnetic wave of the third wavelength, and when the distance is smaller than a predetermined distance threshold, permitting an operation of the vehicle; and
estimating the distance between the vehicle and the mobile terminal using at least the second electromagnetic wave of the second wavelength and the third electromagnetic wave of the third wavelength, and when the distance is greater than the predetermined distance threshold, not permitting the operation of the vehicle.

12. The control method according to claim 11, wherein
the distance between the vehicle and the mobile terminal is estimated based on at least a phase difference between the second electromagnetic wave of the second wavelength and the third electromagnetic wave of the third wavelength.

13. The control method according to claim 11, wherein
the distance is set as a first distance,
the distance threshold is set as a first distance threshold,
the predetermined condition is a case that a second distance estimated based on at least electric field strength and/or electromagnetic wave arrival time of the first electromagnetic wave of the first wavelength is smaller than a second distance threshold, and
the second distance threshold is greater than the first distance threshold.

14. The control method according to claim 11, wherein
the distance is set as a first distance,
the distance threshold is set as a first distance threshold,
the predetermined condition is a case that a second distance estimated based on at least electric field strength and/or electromagnetic wave arrival time of the first electromagnetic wave of the first wavelength is smaller than a second distance threshold and a case that a change in the estimated second distance is greater than a predetermined change, and
the second distance threshold is greater than the first distance threshold.

15. The control method according to claim 11, wherein
the distance is set as a first distance, and
the predetermined condition is a case that a change in a second distance estimated based on at least electric field strength and/or electromagnetic wave arrival time of the first electromagnetic wave of the first wavelength is greater than a predetermined change.

16. The control method according to claim 11, wherein
when the predetermined condition is satisfied, the distance between the vehicle and the mobile terminal is estimated m times using at least an n-th electromagnetic wave of an n-th wavelength and an (n+1)-th electromagnetic wave of an (n+1)-th wavelength,
wherein, n and m are natural numbers of 2 or more, and
m increases as the estimated distance between the vehicle and the mobile terminal decreases.

17. The control method according to claim 11, wherein
a first channel using the first electromagnetic wave of the first wavelength, a second channel using the second electromagnetic wave of the second wavelength, and a third channel using the third electromagnetic wave of the third wavelength are available.

18. The control method according to claim 11, wherein
the second electromagnetic wave of the second wavelength and the third electromagnetic wave of the third wavelength are transmitted from the vehicle to the mobile terminal to estimate the distance between the vehicle and the mobile terminal, and/or
the second electromagnetic wave of the second wavelength and the third electromagnetic wave of the third wavelength are transmitted from the mobile terminal to the vehicle to estimate the distance between the vehicle and the mobile terminal.

19. The control method according to claim 11, wherein
when a vehicle control request is received from a main switch of the vehicle and when communication is performed between the vehicle and the mobile terminal using at least the first electromagnetic wave of the first wavelength and the predetermined condition is satisfied, the distance between the vehicle and the mobile terminal is estimated using at least the second electromagnetic wave of the second wavelength and the third electromagnetic wave of the third wavelength, and when the distance is smaller than the predetermined distance threshold, a control permission signal is transmitted to the vehicle.

20. The control method according to claim 11, wherein
the vehicle control device includes a housing, and
the housing of the vehicle control device includes a holding portion held by a vehicle body of the vehicle.
